(19) United States
(12) Patent Application Publication
(10) Pub. No.: US 2011/0061465 A1
(43) Pub. Date: Mar. 17, 2011

(54) METHOD AND APPARATUS FOR NON-DESTRUCTIVE DETECTION OF DEFECTS IN THE INTERIOR OF SEMICONDUCTOR MATERIAL

(75) Inventor: Klaus KRAEMER, Herborn (DE)

(73) Assignee: INSTITUT FUER AKUSTOMIKROSKOPIE DR. KRAEMER GMBH, Herborn (DE)

(21) Appl. No.: 12/906,726

(22) Filed: Oct. 18, 2010

Related U.S. Application Data
(63) Continuation of application No. PCT/EP2009/054773, filed on Apr. 22, 2009.

(30) Foreign Application Priority Data
Apr. 24, 2008 (DE) 102008002832.0

(51) Int. Cl. G01N 29/04

(52) U.S. Cl. 73/625; 73/620

(57) ABSTRACT

A method and an apparatus for the non-destructive detection of defects in the interior of semiconductor material (2) are disclosed. The semiconductor material (2) has a length (L), a cross-sectional area (Q), and a side surface (5) aligned with the length (L). An ultrasonic apparatus (10) is assigned to the semiconductor material (2). Furthermore a set-up (9) for generating a relative motion between the ultrasonic apparatus (10) and along the length (L) of the side surface (5) of the semiconductor material (2) is provided.

### BACKGROUND OF THE INVENTION

The present invention relates to a method for non-destructive detection of defects in the interior of semiconductor material. The semiconductor material has a length and a cross-sectional area. The semiconductor material thus is bulk material, from which the single discs or plates for the semiconductor products are cut.

The invention also relates to an apparatus for non-destructive detection of defects in the interior of semiconductor material. The semiconductor material has a length, a cross-sectional area, and a side surface aligned with the length.

The German patent application DE 10 2006 032 431 A1 discloses a method for the detection of mechanical defects in a piece of a rod consisting of semiconductor material. The semiconductor material exhibits at least one plane surface, and a thickness of 1 cm to 100 cm, measured perpendicular to this surface. In the method the plane surface of the piece of rod is scanned with at least one ultrasonic transducer, which is coupled to the plane surface of the piece of rod by a liquid coupling medium. At each point of measurement an ultrasonic pulse is directed at least on the plane surface of the piece of rod, and the echo of the ultrasonic pulse generated by the piece of rod is recorded as a function of time, so that an echo from the plane surface, an echo of a surface of the piece of rod opposite the plane surface, and possibly further echoes are detected, wherein the positions of mechanical defects in the piece of rod are detected from the further echoes.

The German patent application DE 29 36 882 discloses a testing apparatus for the detection of material defects in the interior of a component. The testing apparatus is used for components under pressure in nuclear plants. The testing head is moved to the location to be tested by a remote-controlled manipulator. The entire interior of the component is not tested for defects.

The U.S. Pat. No. 6,047,600 discloses a method for testing piezo-electric materials. The time-of-arrival method is used to test the homogeneity of the material.

The U.S. Pat. No. 5,381,693 discloses an imaging ultrasonic apparatus, wherein an object to be tested is scanned, while the object is irradiated with ultrasound. By the focus the plane in the material which is to be tested can be set.

The international patent application WO 02/40987 discloses a method and an apparatus for the acoustic, microscopic investigation of flat substrates. The substrates to be investigated are placed into a wet-environment, in which the ultrasound is coupled in.

### SUMMARY OF THE INVENTION

There is no prior art for inspecting a rod-shaped semiconductor material, of arbitrary size and shape, with an ultrasonic apparatus in such a way that information about possible defects is retrieved from the entire bulk of the semiconductor material.

It is an object of the invention to provide a method by which defects in the interior of a semiconductor material can be detected reliably. Furthermore the method according to the invention shall provide an ultrasonic image of the interior of the semiconductor material.

The above object is achieved by a method according to the features claim 1.

A further object of the invention is to provide an apparatus by which defects in the interior of a semiconductor material can be localized non-destructively. Furthermore the locations of the defects in the interior of the semiconductor material shall be passed to a processing machine for the later processing of the semiconductor material.

The above object is achieved by an apparatus according to the features of claim 6.

It has turned out to be particularly advantageous that with the present invention the detection of defects in the interior of a rod-shaped semiconductor material is possible. The semiconductor material has a length and a cross-sectional area.

In the method according to the invention an ultrasonic apparatus is provided, wherein a relative motion is generated between the ultrasonic apparatus and a side surface of the semiconductor material. Ultrasonic pulses are emitted from the ultrasonic apparatus towards the semiconductor material during the relative motion between the semiconductor material and the ultrasonic apparatus. Parallely thereto an ultrasonic echo-signal of the ultrasonic pulses from the interior of the semiconductor material is recorded in dependence on time and space, so that the defects in the interior of the semiconductor material are detected from the entire bulk of the semiconductor material. The ultrasonic pulses and the ultrasonic echo-signal are coupled to the semiconductor material by a medium. The medium for example can be a liquid. It is also conceivable for the ultrasonic pulses and the ultrasonic echo-signal to be coupled to the semiconductor material by air or some other gaseous medium.

The relative motion between the ultrasonic apparatus and the semiconductor material is generated by moving the ultrasonic apparatus along the length of the semiconductor material.

The semiconductor material can be of cylindrical shape. During the motion of the ultrasonic apparatus along the length of the semiconductor material at least one sector up to the centre of the semiconductor material is captured. The cylindrical semiconductor material is rotated about an axis in order to capture the subsequent at least one sector up to the centre of the semiconductor material. This is continued until the entire bulk of the semiconductor material has been captured and represented as an image.

Furthermore a computer control is provided, by which the ultrasonic echo-signals returning from the interior of the semiconductor material are handled in such a way that ultrasonic echo-signals from the region of the at least one sector are processed, and that the ultrasonic echo-signals from outside the sector are not processed for the imaging.

Furthermore it is possible to investigate a semiconductor material of cuboid shape by the method according to the invention. Here, too, during the motion of the ultrasonic apparatus along the length of a first outer surface of the semiconductor material at least one cuboid up to a central plane of the semiconductor material is captured. The ultrasonic apparatus is displaced transversely to the length of the semiconductor material, so that during the subsequent movement of the ultrasonic apparatus along the length of the first outer surface of the semiconductor material at least one cuboid up to the central plane of the semiconductor material is captured, and that, after all the cuboids from the first surface to the central surface have been captured, the semiconductor material is turned by 180° to capture further cuboids from the second outer surface.

Here, too, a computer control is provided, by which the ultrasonic echo-signals returning from the interior of the semiconductor material are handled in such a way that ultrasonic echo-signals from the region of the at least one cuboid up to the central surface are processed, and the ultrasonic echo-signals outside the at least one cuboid are not processed.

The apparatus for the non-destructive detection of defects in the interior of the semiconductor material comprises an ultrasonic apparatus assigned to the semiconductor material. Furthermore a set-up for generating a relative motion between the ultrasonic apparatus along the length of the side surface of the semiconductor material is provided.

The ultrasonic apparatus may comprise plural transducers, located at a distance from the side surface. The ultrasonic pulses emitted from the transducers are coupled into the semiconductor material by a medium. To this end liquid or gaseous media are conceivable. Depending on the medium used the transducers need to be designed accordingly with respect to their power.

According to an embodiment of the invention the plural transducers are arranged in a row at equal distances. A further embodiment consists in the transducers being arranged at equal distances in a matrix.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

Subsequently embodiments shall illustrate the method according to the invention and the apparatus according to the invention and their advantages with reference to the accompanying figures.

FIG. 1 shows a schematic view of the apparatus for the non-destructive detection of defects in the interior of cylindrical semiconductor material.

FIG. 2 shows a schematic view of an apparatus for the non-destructive detection of defects in the interior of cuboid semiconductor material.

FIG. 3 shows a top view of the circular cross-sectional area and the corresponding linear ultrasonic apparatus.

FIG. 4 shows a top view of the circular cross-sectional area and the corresponding matrix-like ultrasonic apparatus.

FIG. 5 shows a top view of the rectangular cross-sectional area and the corresponding linear ultrasonic apparatus.

FIG. 6 shows a top view of the rectangular cross-sectional area and the corresponding matrix-like ultrasonic apparatus.

FIG. 7 shows a possible embodiment of the linear arrangement of the individual transducers with respect to the side surface of the semiconductor material.

FIG. 8 shows a possible embodiment of the matrix-like arrangement of the individual transducers with respect to the side surface of the semiconductor material.

For like elements of the invention or elements of like function identical reference numerals are used. Furthermore only those reference numerals are used in the individual figures which are necessary for the description of the respective figure.

### DETAILED DESCRIPTION OF THE PREFERRED EMBODIMENTS

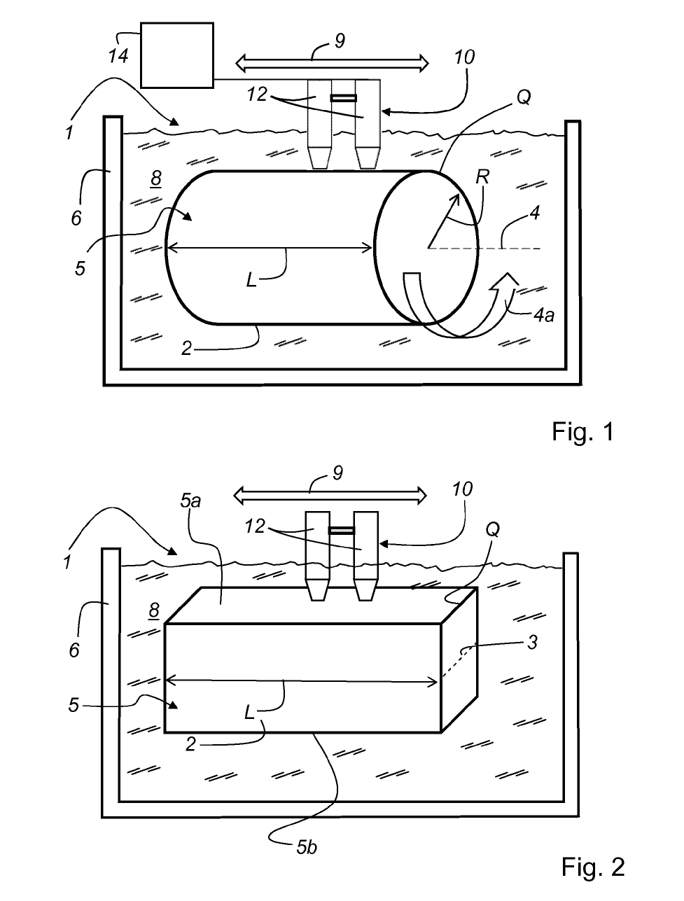

FIG. 1 shows a schematic view of the apparatus 1 for the non-destructive detection of defects in the interior of cylindrical semiconductor material 2. With the apparatus 1 according to the invention semiconductor materials 2 of arbitrary cross-section Q can be investigated. In the embodiment shown in FIG. 1 the semiconductor material 2 has a circular cross-section Q. The shapes of the cross sections shown here are not to be taken by way of limitation of the invention. It is possible to investigate the rod-shaped semiconductor material 2 of arbitrary cross-sections with the apparatus 1 according to the invention.

The semiconductor material 2 to be investigated therein is placed in a container 6 filled with a liquid 8. The ultrasonic apparatus 10 comprises plural transducers 12, from which the emitted ultrasonic pulses are coupled to the semiconductor material 1 via the liquid 8. Though in the figures a liquid is shown as the medium used, this is not to be taken as a limitation of the invention. It is also conceivable that the ultrasonic pulses and the ultrasonic echo-signal are coupled to the semiconductor material via air or some other gaseous medium. The coupling via air is not shown in the figures, it is obvious to a person skilled in the art how to design the transducers with respect to power so that the coupling via air yields satisfactory results with respect to the defects in the interior of the semiconductor material 1. According to the double arrow 9 shown in FIG. 1 the ultrasonic apparatus 10 can be moved relative to the semiconductor material 2 along its length L. A control and evaluation device 14 is provided. The control and evaluation device 14 thus also serves for the control of the relative motion between the ultrasonic apparatus 10 and the semiconductor material 2, for the control of the emission of ultrasonic pulses onto the semiconductor material 2 and parallely thereto also for recording the ultrasonic echo-signal from the interior of the semiconductor material 2. The relative motion is along the length L of the semiconductor material 2. In order to capture the entire bulk of the semiconductor material 2 with the apparatus 1 according to the invention, the semiconductor material 2 is mounted so that it may be rotated about an axis 4. The direction of rotation of the rod-shaped semiconductor material 2 is indicated in FIG. 1 by the arrow 4a. The ultrasonic apparatus 10 is located opposite the side surface 5 of the semiconductor material 2.

FIG. 2 shows a schematic view of the apparatus 1 for the non-destructive detection of defects in the interior of cuboid semiconductor material 2. Here the ultrasonic apparatus 10 at first is located opposite a first surface 5a of the side surface 5 of the semiconductor material 2. First the first surface 5a of the side surface 5 of the semiconductor material 2 is scanned with the ultrasonic apparatus 10. Thus the interior of the semiconductor material 2 up to a central plane 3 is captured with the ultrasonic apparatus 10. After capturing this part of the semiconductor material 2, the semiconductor material 2 is turned by 180°, and the second surface 5b, which is opposite the first surface 5a, is scanned. In this way the second part of the bulk of the semiconductor material 2 is captured.

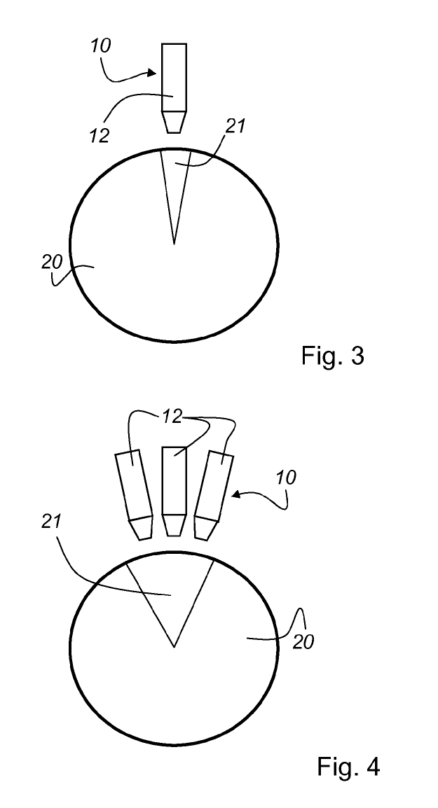

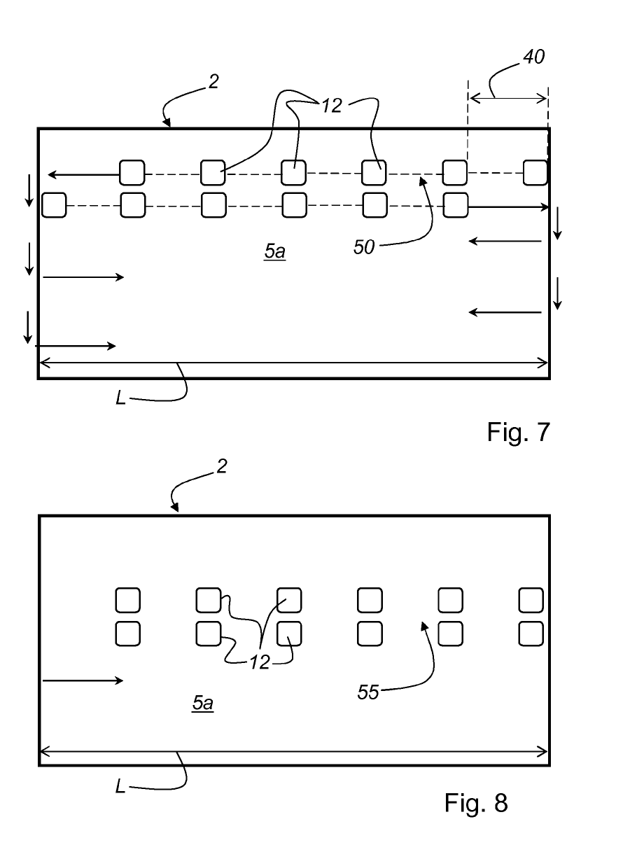

FIG. 3 shows a top view of the circular cross-sectional area 20 and of the linear ultrasonic apparatus 10. The at least one transducer 12 of the ultrasonic apparatus 10 therein is located in such a way that it is opposite a line (see FIG. 7) of the side surface 5. The ultrasonic apparatus 10 and the control and evaluation device 14 therein cooperate in such a way that a sector of a circle 21 up to the centre M of the semiconductor material 2 is captured of the semiconductor material 2. The sector of a circle 21 extends along the length L of the semiconductor material 2. Once a sector of a circle 21 has been captured, the semiconductor material 2 is rotated about the axis 4 and the subsequent sector of a circle 21 is captured with the ultrasonic apparatus 10.

FIG. 4 shows a top view of the circular cross-sectional area 20 and the linear ultrasonic apparatus 10. The ultrasonic apparatus 10 comprises plural transducers 12 arranged in a matrix. The representation in FIG. 4 shows the first row of the matrix. Therein the transducers 12 are located in such a way with respect to the semiconductor material 2 that each transducer exhibits the same distance from the side surface 5 of the semiconductor material 2. The ultrasonic apparatus 10 and the control and evaluation device 14 therein cooperate in such a way that a sector of a circle 21 up to the centre M of the semiconductor material 2 is captured of the semiconductor material 2. The sector of a circle 21 extends along the length L of the semiconductor material 2. Once a sector of a circle 21 has been captured, the semiconductor material 2 is rotated about the axis 4 and the subsequent sector of a circle 21 is captured with the ultrasonic apparatus 10. The sector of a circle 21 captured with the matrix arrangement is larger than the sector of a circle captured with the linear arrangement of plural transducers 12.

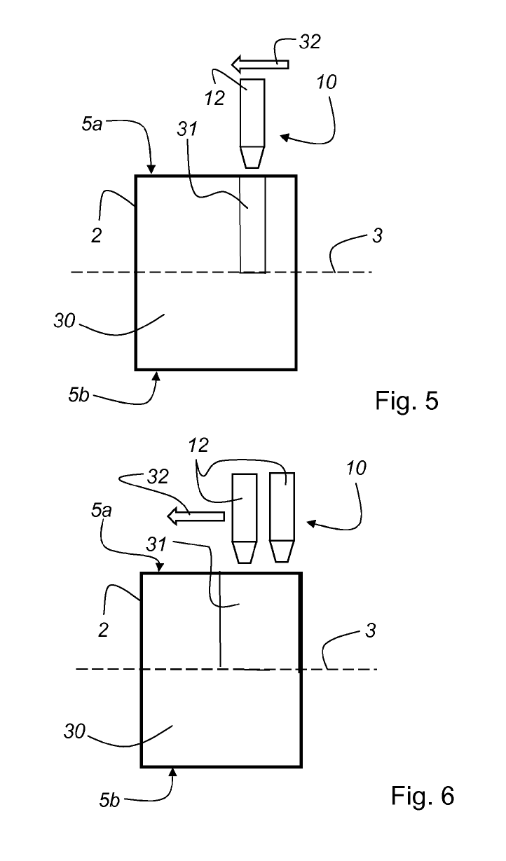

FIG. 5 shows a top view of the rectangular cross-sectional area 30 and the linear ultrasonic apparatus 10. The at least one transducer 12 of the ultrasonic apparatus 10 therein is arranged in such a way that it is located opposite a part of the first surface 5a of the side surface 5. The ultrasonic apparatus 10 and the control and evaluation device 14 (see FIG. 1) therein cooperate in such a way that a cuboid 31 up to the central plane 3 of the semiconductor material 2 is captured of the semiconductor material 2. The cuboid 31 extends along a length L of the semiconductor material 2. Once a cuboid 31 has been captured, the ultrasonic apparatus 10 is displaced (in direction of the arrow 32), so that the next cuboid can be captured with the ultrasonic apparatus 10. Once all cuboids 31 from the first surface 5a to the central plane 3a have been captured, the semiconductor material 2 is turned by 180°. Then the plurality of cuboids 31 from the second surface 5b of the side surface 5 to the central plane 3 are captured. In this way it is possible to capture the entire bulk of the semiconductor material 2 with a rectangular cross section 30. Though the description is limited to a rectangular shape, this is not to be taken as a limitation of the invention. The cross section can have the shape of a square also, or deviate somewhat from the rectangular or square shape.

FIG. 6 shows a top view of the rectangular cross-sectional area 30 and the matrix-like ultrasonic apparatus 10 for capturing the entire bulk of the semiconductor material 2. The difference to the embodiment shown in FIG. 5 is that a larger cuboid 31 can be captured with the matrix arrangement of the transducers 12 than with the arrangement of FIG. 5. The individual transducers 12 of the matrix arrangement therein are essentially arranged parallel to the first surface 5a or the second surface 5b, respectively.

FIG. 7 shows a possible embodiment of the linear arrangement of the individual transducers 12 with respect to the side surface 5 of the semiconductor material 2. In the embodiment shown here for example the first surface 5a of the semiconductor material 2 is scanned with the linear arrangement (row arrangement 50) of the transducers 12. The individual transducers 12 are located at an equal distance 40 from each other along the length L of the semiconductor material. For capturing a cuboid 31 of the interior of the semiconductor material 2 up to the central plane 3 (see FIG. 5) the row arrangement 50 is displaced by the value of the distance 40. In this way at least a part of the bulk of the semiconductor material 2 is captured within a relatively short time. For the next section of the bulk of the semiconductor material 2 to be captured the row arrangement 50 of the transducers 12 is displaced perpendicular to the length L of the semiconductor material 2. Afterwards again a displacement of the row arrangement 50 by the value of the distance 40 follows. This is continued until the entire first surface 5a has been scanned and the corresponding bulk of the semiconductor material 2 has been captured.

FIG. 8 shows a possible embodiment of the matrix-like arrangement of the individual transducers 12 with respect to the first surface 5a of the side surface 5 of the semiconductor material 4. The entire matrix 55 of the transducers 12 is displaced according to the sequence shown in FIG. 7. It is self-evident that a larger region of the bulk of the semiconductor material 2 can be captured with the matrix 55 than with the embodiment shown in FIG. 7. In the case of a matrix arrangement the signal-processing effort for the ultrasonic echo-signal returning from the interior of the semiconductor material 2 is higher.

The invention has been described with reference to a preferred embodiment. It is obvious for a person skilled in the art, however, that alterations or modifications of the invention can be made without leaving the scope of the subsequent claims.

What is claimed is:

1. A method for non-destructive detection of defects in an interior of a semiconductor material (2) which has a length (L) and a cross-sectional area (Q), comprising:
that an ultrasonic apparatus (10) is provided, wherein between the ultrasonic apparatus (10) and a side surface (5) of the semiconductor material (2) a relative motion is generated, which moves the ultrasonic apparatus (10) along the length (L) of the semiconductor material (2);
emitting ultrasonic pulses from the ultrasonic apparatus (10) towards the semiconductor material (2) during the relative motion between the semiconductor material (2) and the ultrasonic apparatus (10), that parallely thereto an ultrasonic echo-signal from the interior of the semiconductor material (2) to the ultrasonic pulses is recorded in dependence on time and space,
capturing during the movement of the ultrasonic apparatus (10) along the length (L) of the semiconductor material (2) with a computer control at least one sector up to a centre (M) of the semiconductor material (2) in case the semiconductor material (2) has a cylindrical shape and the ultrasonic echo-signals returning from the interior of the cylindrical semiconductor material (2) are handled in such a way that ultrasonic echo-signals from the region of the at least one sector (21) are processed and that the ultrasonic echo-signals outside the sector (21) are not processed or capturing during the movement of the ultrasonic apparatus (10) along the length (L) of a first outer surface of the semiconductor material (2) with the computer control at least one cuboid (31) up to a central plane (3) of the semiconductor material (2) in case the semiconductor material (2) has a cuboid shape, wherein the ultrasonic echo-signals returning from the interior of the semiconductor material (2) are handled in such a way that ultrasonic echo-signals from the region of the at least one cuboid (31) up to the central plane (3) are processed and the ultrasonic echo-signals outside the at least one cuboid are not processed, so that the defects in the interior of the semiconductor material (2) are captured from the entire bulk of the semiconductor material (2); and
coupling the ultrasonic pulses and the ultrasonic echo-signal to the semiconductor material (2) by a medium (8).

2. The method of claim 1, wherein in the case of the cylindrical semiconductor material (2) the semiconductor material (2) is rotated about an axis (4) after the movement of the ultrasonic apparatus (10) along the length (L) of the semiconductor material (2), in order to capture the subsequent at least one sector (21) up to a centre (M) of the semiconductor material (2) with the ultrasonic apparatus (10).

3. The method of claim 1, wherein in the case of the cuboid shape of the semiconductor material the ultrasonic apparatus (10) is displaced transversely to the length (L) of the semiconductor material (2), that during the subsequent movement of the ultrasonic apparatus (10) along the length (L) of the first outer surface of the semiconductor material (2) the at least one cuboid (31) up to the central plane (3) of the semiconductor material (2) is captured, and that after all cuboids (31) from the first surface (5a) to the central plane (3) of the semiconductor material (2) have been captured, the semiconductor material (2) is turned by 180°, to capture the further cuboid (31) from the second outer surface (5b).

4. An apparatus for non-destructive detection of defects in an interior of a semiconductor material (2), wherein the semiconductor material (2) has a length (L), a cross-sectional area (Q) and a side surface (5) aligned with the length (L), and wherein the apparatus is designed for the investigation of the semiconductor material (2) with a cylindrical shape or of the semiconductor material (2) with a cuboid shape, an ultrasonic apparatus (10) is assigned to the semiconductor material (2), and that a set-up (9) for generating a relative motion between the ultrasonic apparatus (10) and along the length (L) of the side surface (5) of the semiconductor material (2) is provided, characterized in that the ultrasonic apparatus (10) and a control device for the control of the relative motion between the ultrasonic apparatus (10) and the semiconductor material (2), for the control of the emission of ultrasonic pulses onto the semiconductor material (2) and parallely thereto for recording an ultrasonic echo-signal from the interior of the semiconductor material (2) is designed in such a way that in the case of a cylindrical shape of the semiconductor material (2) along the length (L) of the semiconductor material (2) at least one sector up to a centre (M) of the semiconductor material (2) is inspected in such a manner, so that the ultrasonic echo-signals returning from the interior of the cylindrical semiconductor material (2) are handled in such a way that ultrasonic echo-signals from the region of the at least one sector (21) are processed and that the ultrasonic echo-signals outside the sector (21) are not processed or that in the case of a cuboid shape of the semiconductor material (2) during the movement of the ultrasonic apparatus (10) along the length (L) of a first outer surface of the semiconductor material (2) at least one cuboid (31) up to a central plane (3) of the semiconductor material (2) is inspected in such a manner, so that the ultrasonic echo-signals from the region of the at least one cuboid (31) up to the central plane (3) are processed and the ultrasonic echo-signals outside the at least one cuboid are not processed.

5. The apparatus of claim 4, wherein the ultrasonic apparatus (10) comprises plural transducers (12) which are located at a distance from the side surface (5) and that the ultrasonic pulses from the transducers (12) into the semiconductor material (2) and the ultrasonic echo-signal from the semiconductor material (2) into the transducers (12) are coupled via a medium.

6. The apparatus of claim 5, wherein the medium is a liquid.

7. The apparatus of claim 5, wherein the medium is gaseous.

8. The apparatus of claim 5, wherein the plural transducers (12) are arranged at an equal distance (40) in a row.

9. The apparatus of claim 5, wherein the plural transducers (12) are arranged at an equal distance (40) in a matrix (55).

10. The apparatus of claim 4, wherein in the case of the semiconductor material (2) of cylindrical shape a row arrangement (50) of the transducers (12) is arranged in such a way with respect to the side surface (5) of the semiconductor material (2) that the transducers (12) are located opposite a generatrix of the side surface of the semiconductor material (2).

11. The apparatus of claim 4, wherein in the case of the semiconductor material (2) of cylindrical shape a matrix arrangement of the transducers (12) is arranged in such a way with respect to the side surface (5) of the semiconductor material (2) that the transducers (12) are located opposite at least one segment of the side surface (5) of the semiconductor material (2).

12. The apparatus of claim 4, wherein in the case of the semiconductor material (2) with a cuboid shape a row arrangement (50) of the transducers (12) is arranged in such a way with respect to one of the four surfaces of the side surface (5) of the semiconductor material (2) that the transducers (12) essentially are located opposite a line of the surface of the semiconductor material (2).

13. The apparatus of claim 4, wherein in the case of the semiconductor material (2) of cuboid shape a matrix arrangement of the transducers (12) is arranged in such a way with respect to one of the four surfaces of the side surface (5) of the semiconductor material (2) that the transducers (12) are located opposite at least a part of one of the four surfaces of the side surface (5) of the semiconductor material (2).
